(19) United States
(12) Patent Application Publication
(10) Pub. No.: US 2021/0357917 A1
(43) Pub. Date: Nov. 18, 2021

(54) ACCOUNT REBALANCING DAEMON FOR USE WITH SECURE DIGITAL ASSET CUSTODIANS

(71) Applicant: PayPal, Inc., San Jose, CA (US)

(72) Inventor: Charles Gabriel Neale Dalton, San Jose, CA (US)

(21) Appl. No.: 16/875,839

(22) Filed: May 15, 2020

(51) Int. Cl. G06Q 20/36; G06Q 20/06

(52) U.S. Cl. CPC G06Q 20/3676; H04L 63/1441; G06Q 20/3674; G06Q 20/065

(57) ABSTRACT

There are provided systems and methods for an account rebalancing daemon for use with secure digital asset custodians. A service provider server, such as an electronic transaction processor, may provide cryptocurrency functions and operations associated with use of an online digital platform that trades and secures cryptocurrencies. The service provider may have a digital wallet that allows for storage of cryptocurrency on the online platform. However, these digital wallets may be vulnerable to computing exploits that may obtain cryptocurrencies through computing attacks, hacking operations, and the like. Thus, the service provider may provide for an automated daemon application or process that utilizes a secure digital wallet using secure computing hardware and authorizations to maintain a balance between the digital wallets to reduce risk. This daemon may automatically detect balance data and may execute operations to rebalance the digital wallets.

### TECHNICAL FIELD

The present application generally relates to securing digital assets and cryptocurrency from malicious computing attacks and fraud, and more particularly to an automated daemon operation that performs rebalancing of digital wallets holding cryptocurrency on different online platforms to reduce risk.

### BACKGROUND

Cryptocurrency may correspond to digital assets that users (e.g., end users, merchants, banks and financial institutions, and the like) may trade, exchange, purchase, and sell for values that may change quickly. Cryptocurrency generally utilizes a strong cryptography that controls the generation of additional cryptocurrency units, as well as verify the trading of the cryptocurrency and secure financial transactions conducted using the cryptocurrency. Currently, many online platforms allow for trading of cryptocurrency. As cryptocurrency is digital, users require digital wallets (which can be a hardware wallet or a desktop/mobile wallet) to store and secure the cryptocurrency, which may be provided on the online digital trading platforms. However, as cryptocurrency is a digital product and may be unregulated or less regulated and secure, cryptocurrency is vulnerable to theft and other malicious acts. For example, over the last few years, several prominent cryptocurrency trading platforms have been compromised and cryptocurrency has been stolen from digital wallets. While users may look to offline storage processes, such as in local drives or with secure custodians that may have a private network or intranet that protects the cryptocurrency from external threats, these secure storage mediums cost significant amounts of time to use.

### BRIEF DESCRIPTION OF THE DRAWINGS

FIG. 1 is a block diagram of a networked system suitable for implementing the processes described herein, according to an embodiment;

FIG. 2A-C are exemplary system interactions executed by a rebalancing daemon when performing account rebalancing with external partner platforms, according to an embodiment;

FIG. 3 is an exemplary system environment where a service provider server may interact with different partner platforms to perform account balancing to secure cryptocurrency, according to an embodiment;

FIG. 4 is a flowchart of an exemplary process for an account rebalancing daemon for use with secure digital asset custodians, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for an account rebalancing daemon for use with secure digital asset custodians. Systems suitable for practicing methods of the present disclosure are also provided.

A service provider may provide cryptocurrency services to users, including providing and/or servicing one or more digital wallets storing cryptocurrency. The service provider may also provide transaction processing services to buy, sell, and otherwise trade cryptocurrency, as well as securely protecting the cryptocurrency using a secure custodian platform or internally secured storage medium. Since cryptocurrency is digital in nature, the service provider may risk theft or loss of cryptocurrency if not securely protected. For example, computing attacks including malware, phishing schemes, and other malicious acts by bad actors may compromise the service provider's computing infrastructure and risk fraud in electronic transaction processing using cryptocurrency or unauthorized transfer and theft of the cryptocurrency.

To protect from these malicious acts and risk to stored cryptocurrency, the service provider may utilize an application or daemon that performs automated processes in the background to continuously and/or periodically secure cryptocurrency in possession of or accessible to the service provider. The daemon may be utilized to automate processes to rebalance cryptocurrency between a first digital wallet, such as a liquidity digital wallet that stores cryptocurrency in an easily available wallet account that is quickly available to trade, and a second secure digital wallet, such as a custodian digital wallet. This second secure digital wallet may be secured utilizing additional hardware and/or operations that may make the cryptocurrency generally unavailable to users without authorization from another user or entity. The daemon may detect when cryptocurrency within one of the wallets is above, at, or below a threshold to execute an automated process to rebalance each wallet to a selected amount. In this manner, only a portion of the service providers cryptocurrency is exposed to external threats through the first digital wallet, while the remaining amount in the more secure second digital wallet is less exposed. Further, the first digital wallet that may have faster processing times for trading cryptocurrency and may maintain a balance that allows for immediate or faster cryptocurrency trading operations on the liquidity platform.

For example, the service provider may provide electronic transaction processing associated with cryptocurrency to users, including individual end users, merchants, and financial entities that may wish to process transactions and/or trade cryptocurrency. Moreover, a user may view other digital account and/or digital wallet information, including available cryptocurrency to the user and/or service provider via a digital ledger. To utilize the cryptocurrency services, a user may establish an account and other information for the user through the service provider. An account with a service provider may be established by providing account details, such as a login, password (or other authentication credential, such as a biometric fingerprint, retinal scan, etc.), and other account creation details. The account creation details may include identification information to establish the account, such as personal information for a user, business or merchant information for an entity, or other types of identification information including a name, address, and/or other information. The user may also be required to provide financial information, including payment card (e.g., credit/debit card) information, bank account information, gift card information, benefits/incentives, and/or financial investments, which may be used to process transactions after identity confirmation. The online payment provider may provide account and/or digital wallet services, which may be utilized to trade and store cryptocurrency. An application or website of the service provider, such as PayPal® or other online payment provider, may be utilized to engage in these cryptocurrency services.

Thus, the online service provider may provide account services to users of the online service provider, which may be used with cryptocurrency available to the service provider and/or with integrated partner platforms. The service provider may include either an internal digital wallet that stores cryptocurrency available to and traded by the service provider and/or may be integrated with a cryptocurrency liquidity partner platform that allows for trading cryptocurrency by users of the service provider, such as purchasing and selling cryptocurrency. The liquidity platform may therefore correspond to a cryptocurrency exchange where users engage in trading digital assets for different cryptocurrencies. Where the service provider stores available cryptocurrency on the liquidity platform, the service provider may store such liquid cryptocurrency in a liquidity digital wallet. This liquidity digital wallet may allow direct trading out of liquidity wallet, such as on an exchange or other liquidity platform for the liquidity partner. This digital wallet may therefore be used to buy and sell cryptocurrency on the exchange of the liquidity platform. Conversely, a custodian digital wallet may not allow trading directly or may require certain requirements to be met prior to allowing trading and exchange of cryptocurrency, but may provide enhanced security in storing cryptocurrency. The service provider may maintain a ledger of cryptocurrency available to each user with the service provider, which may be used to display an amount of cryptocurrency available to a user through their account. Thus, the user's account may be used to perform cryptocurrency trading transactions through the liquidity digital wallet of the service provider.

Further, the online service provider may include or be integrated with a secure digital asset custodian platform. This secure custodian platform corresponds to hardware and/or software that secures cryptocurrency from external threats and malicious sources, including theft. For example, the secure custodian may reside on a disk drive or database that is offline or inaccessible to computing devices except for authorized device(s) and/or user(s). The secure custodian platform may also reside on an internal network or intranet that is protected from external sources of the service provider and/or third-party secure custodian. The custodian platform may also protect from internal threats through the use of group authorizations to allow transfer of cryptocurrency out of (or into if needed) a secure custodian digital wallet maintained by the hardware and software of the secure custodian. Thus, in order to transfer cryptocurrency out of the custodian digital wallet, an authorization, approval, or other consent may be required from an administrator, authority entity, or specific trusted user of the service provider and/or custodian platform. The digital ledger of the service provider may further keep records of the cryptocurrency available to the custodian digital wallet, as well as transactions using the cryptocurrency in the custodian digital wallet (e.g., deposits, withdrawals, and/or trades).

Where the liquidity digital wallet and custodian digital wallet are on external platforms, the service provider may include one or more application programming interface (API) integrations with the exposed APIs of the external liquidity platform and custodian platform. The liquidity platform and the custodian platform may be on the same or different external digital platforms or may also be provided by the service provider. When on the same platform, different computing architectures may be used to provide the cryptocurrency trading with the liquidity wallet and the security for the secure custodian wallet. This may allow for API calls to be exchanged and operations utilizing each digital wallet to be processed and executed. For example, when performing a transaction for cryptocurrency in the liquidity wallet that may be requested by a user of the service provider (e.g., a purchase or sale of cryptocurrency), a daemon (e.g., a computing application or process that continuously or intermittently operates without user input and in a background) may make an API call to receive data from the liquidity platform. The data may correspond to quotes, values, or prices of cryptocurrencies available on the liquidity platform, including different types of cryptocurrency (e.g., Bitcoin, Litecoin, Ethereum, etc.). In some embodiments, the liquidity platform may continuously publish data to the service provider of the quotes and values for different cryptocurrency types.

Thereafter, the user may view cryptocurrency prices through their account and/or available cryptocurrency trading operations of the service provider. The user may request a trade for a particular cryptocurrency and amount or value, such as a request that the liquidity platform buy and deposit an amount of cryptocurrency into the liquidity wallet, or conversely sell and withdraw an amount from the liquidity wallet to provide to another user. The daemon may perform read calls to access and/or information for the liquidity wallet on the liquidity platform and custodian wallet on the secure custodian platform. For example, the daemon may execute periodic or continuous balance checks of a balance within each of the liquidity wallet and the custodian wallet to determine a total amount or balance of cryptocurrency held by or accessible to the service provider. Further the daemon may implement operations to receive a balance and/or amount within one of the liquidity wallet or the custodian wallet when those wallets are below or at a minimum balance threshold or above or at a maximum balance threshold. Thus, the daemon may receive information on the balance of cryptocurrency held by each of the liquidity wallet and the custodian wallet. Where more than two wallets may store cryptocurrency of the user, additional digital wallets may also be checked for balance inquiries to determine a total amount of cryptocurrency available to the service provider. In some embodiments, only the liquidity wallet may be checked by the daemon for the balance where the amount of cryptocurrency in the custodian wallet may be known or determined based on past transfers.

The daemon may include one or more automated operations to trigger and perform a rebalancing of the liquidity digital wallet and the custodian digital wallet when the balances of one or more of the digital wallets is above, at, or below a specific threshold. For example, the daemon may normally require that the liquidity digital wallet maintains a balance of 10% of the cryptocurrency available to the service provider. Thus, the custodian wallet may then store 90% of the cryptocurrency in a secure manner so that the majority of the service provider's cryptocurrency is not compromised or stored in a less secure manner that is open to threats and theft. If the liquidity digital wallet meets or exceeds a maximum percentage amount of the available cryptocurrency of the service provider (e.g., based on purchase transactions of cryptocurrency), such as 15%, then the daemon may determine that a rebalancing operation is to be executed to move an amount of the cryptocurrency corresponding to the extra 5% from the liquidity wallet to the custodian wallet. Conversely, if the liquidity digital wallet meets or falls below a minimum threshold (e.g., based on sale transactions of cryptocurrency), such as 5%, then the daemon may determine that the rebalance operation may be required to move an amount of cryptocurrency from the custodian wallet to the liquidity wallet, where the amount may correspond to the 5% amount required to cause the liquidity wallet to have a balance of 10% of the overall cryptocurrency. The amount required to rebalance the digital wallets may be a number of cryptocurrency units in one or more of the wallets (e.g., 1,000 Bitcoin in the liquidity wallet), a value of the cryptocurrency (e.g., $1,000 worth of Litecoin in the liquidity wallet), or a percentage of the overall cryptocurrency available to the service provider.

In various embodiments, the daemon may perform periodic checks of the liquidity digital wallet and/or the custodian digital wallet in order to determine whether a rebalancing operation is to be executed based on violation of a threshold by a balance in one or more of the digital wallets. Thus, the daemon may detect the balance of cryptocurrency (e.g., every hour, 30 minutes, etc.) for one or more of the digital wallets. Additionally, the daemon may rebalance on a periodic basis (e.g. every 24 hours). However, the daemon and/or an operation of the liquidity platform and/or custodian platform may also include a process to execute an emergency rebalance not at a scheduled rebalancing in response to a certain condition. For example, an emergency condition may occur where a balance is at or falls below an emergency minimum threshold for cryptocurrency in the liquidity wallet, such as 2% or 0% where no transactions for trades of cryptocurrency can occur. Conversely, a large transaction and/or many transactions may cause the liquidity wallet's balance to exceed a maximum threshold for an emergency rebalancing (e.g., 20% of the cryptocurrency in the liquidity wallet, which is associated with a large security risk). Thus, the daemon may also execute a rebalancing operation in response to detected conditions and balances. In this regard, the emergency threshold may trigger the rebalancing operation of the daemon to be executed.

When rebalancing from the liquidity digital wallet to the custodian digital wallet, the daemon may execute the rebalancing operation for the amount to rebalance the digital wallets to the target goal balances without user input and/or consent. As the liquidity wallet does not require an authorization or consent to transfer, trade, buy, or sell cryptocurrency, the daemon may automatically cause the rebalancing amount to be transferred to the custodian wallet. Thus, this may be done instantaneously or in near real-time to cause the balances to be rebalanced. However, when withdrawing cryptocurrency from the custodian wallet, an authorization or consent is required, which may include a group consent from multiple parties. As such, the daemon may execute an operation to request the approval from an internal administrator, administrative group, or other authorization entity for the service provider. In some embodiments, the authorization may come from administrators of the custodian platform and therefore the daemon may query the custodian platform (e.g., through an API call) and request the authorization. Once the authorization is received, the daemon may utilize the authorization to request a transfer from the custodian wallet to the digital wallet, for example, by executing one or more API calls to the custodian platform to cause the transfer and rebalancing of the liquidity wallet from the custodian wallet.

Furthermore, the daemon may continue to monitor the liquidity digital wallet and the custodian digital wallet for additional rebalancing. This may occur as additional cryptocurrency transactions are executed on the liquidity platform using the liquidity wallet. In this manner, the service provider may reduce risk and fraud caused by computing attacks on digital assets. This allows the digital assets to be more trusted and does not allow for malicious computing sources to access certain digital wallets. Moreover, the daemon operates in an automated manner, reducing and/or removing the need for user input and processing. This increasing processing speed in performing the rebalancing operations and reduces overall use of the system by different users.

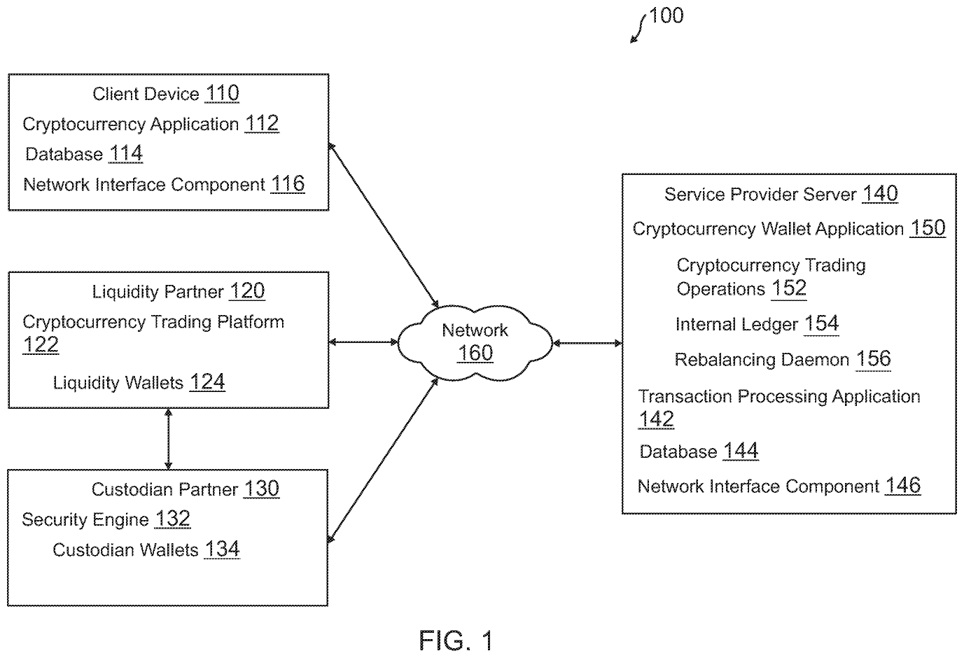

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entity.

System 100 includes a client device 110, a liquidity partner 120, a custodian partner 130, and a service provider server 140 in communication over a network 160. Client device 110 may be utilized by a user to access a cryptocurrency trading platform and cryptocurrency wallet application with service provider server 140. Service provider server 140 may include one or more operations to trade cryptocurrencies using liquidity partner 120 and custodian partner 130.

Client device 110, liquidity partner 120, custodian partner 130, and service provider server 140 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

Client device 110 may be implemented as a communication device that may utilize appropriate hardware and software configured for wired and/or wireless communication with service provider server 140. For example, in one embodiment, client device 110 may be implemented as a personal computer (PC), a smart phone, laptop/tablet computer, wristwatch with appropriate computer hardware resources, eyeglasses with appropriate computer hardware (e.g. GOOGLE GLASS®), other type of wearable computing device, implantable communication devices, and/or other types of computing devices capable of transmitting and/or receiving data, such as an IPAD® from APPLE®. Although only one device is shown, a plurality of devices may function similarly and/or be connected to provide the functionalities described herein.

Client device 110 of FIG. 1 contains a cryptocurrency application 112, a database 114, and a network interface component 116. Cryptocurrency application 112 may correspond to executable processes, procedures, and/or applications with associated hardware. In other embodiments, client device 110 may include additional or different modules having specialized hardware and/or software as required.

Cryptocurrency application 112 may correspond to one or more processes to execute software modules and associated components of client device 110 to provide features, services, and other operations for trading of cryptocurrency through a digital wallet and platform provided by service provider server 140 that is rebalanced using a daemon application or operation. In this regard, cryptocurrency application 112 may correspond to specialized hardware and/or software utilized by a user of client device 110 that may be used to access a web site or a UI provided by service provider server 140. Cryptocurrency application 112 may utilize one or more UIs, such as graphical user interfaces presented using an output display device of client device 110, to trade cryptocurrency using service provider server 140, such as by purchasing cryptocurrency and/or selling cryptocurrency through liquidity partner 120. Cryptocurrency application 112 may therefore be used to view quotes for cryptocurrency values and engage in electronic transaction processing for cryptocurrency.

In some embodiments, cryptocurrency application 112 may include services for electronic transaction processing provided by service provider server 140. As discussed herein, cryptocurrency application 112 may utilize user financial information, such as credit card data, bank account data, or other funding source data, as a payment instrument when providing payment information including purchase or sale of cryptocurrency and/or use of cryptocurrency in transactions. Additionally, cryptocurrency application 112 may utilize a digital wallet associated with an account with a payment provider, such as service provider server 140, as the payment instrument, for example, through accessing a digital wallet or account of a user with service provider server 140 through entry of authentication credentials and/or by providing a data token that allows for processing using the account. Cryptocurrency application 112 may also be used to receive a receipt or other information based on transaction processing.

Client device 110 may further include database 114 stored on a transitory and/or non-transitory memory of client device 110, which may store various applications and data and be utilized during execution of various modules of client device 110. Database 114 may include, for example, identifiers such as operating system registry entries, cookies associated with cryptocurrency application 112 and/or other applications 112, identifiers associated with hardware of client device 110, or other appropriate identifiers, such as identifiers used for payment/user/device authentication or identification, which may be communicated as identifying the user/client device 110 to service provider server 140. Moreover, database 114 may include access and/or authentication information, as well as information for available cryptocurrency and/or trading of cryptocurrency.

Client device 110 includes at least one network interface component 116 adapted to communicate with service provider server 140. In various embodiments, network interface component 116 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Liquidity partner 120 may be maintained, for example, by an online service provider, which may provide cryptocurrency trading through a platform and digital wallet that allows for buying and selling of cryptocurrency. In this regard, liquidity partner 120 includes one or more processing applications which may be configured to interact with client device 110 and service provider server 140 to facilitate the trading of cryptocurrency, including rebalancing of a liquidity wallet of service provider server 140 on the trading platform provided by liquidity partner 120. In some embodiments, liquidity partner 120 may further be provided by service provider server 140. Although only one partner is shown, a plurality of partner platforms may function similarly and/or be connected to provide the functionalities described herein.

Liquidity partner 120 of FIG. 1 contains a cryptocurrency trading platform 122 corresponding to executable processes, procedures, and/or applications with associated hardware. In other embodiments, liquidity partner 120 may include additional or different modules and platforms having specialized hardware and/or software as required. Cryptocurrency trading platform 122 may correspond to an online digital platform that allows for buying, selling, and utilizing cryptocurrencies through one or more operations, including trading values and quotes for buying and selling of cryptocurrencies (e.g., prices and historical price data). Liquidity partner 120 may provide for the trading of different cryptocurrencies, such as Bitcoin, Litecoin, Ether, and the like on cryptocurrency trading platform 122. Further, liquidity partner 120 may provide liquidity wallets 124 where values and amounts of the cryptocurrencies may be held on cryptocurrency trading platform 122 for trading cryptocurrencies. Service provider server 140 may be in possession or have one of liquidity wallets 124, where cryptocurrency amounts available to service provider server 140 for trading is held by liquidity partner 120. The cryptocurrency in liquidity wallets 124, such as the digital wallet for liquid cryptocurrency of service provider server 140, may be traded based on requests from client device 110 and other users. For example, service provider server 140 may provide a digital ledger of cryptocurrency for different users that has been purchased, sold, and otherwise traded using cryptocurrency trading facilitated by service provider server 140. Further, to prevent theft and fraud, service provider server 140 may utilize a rebalancing daemon to maintain a certain balance (e.g., percentage, percentage range, or amount within a range) of cryptocurrency in a digital wallet of service provider server 140 of liquidity wallets 124. Liquidity partner 120 may be accessible over network 160 to provide the cryptocurrency trading platform and processes requested and utilized by client device 110 and service provider server 140.

Custodian partner 130 may be maintained, for example, by an online service provider, which may provide digital security vaults and other security features to secure cryptocurrency in a secure and/or offline environment. In this regard, custodian partner 130 includes one or more processing applications and corresponding hardware, which may be configured to interact with client device 110 and service provider server 140 to facilitate holding cryptocurrency in a secure digital wallet, including rebalancing of a secure custodian wallet of service provider server 140 with security engine 132. In some embodiments, custodian partner 130 may further be provided by service provider server 140. Although only one partner is shown, a plurality of partner platforms may function similarly and/or be connected to provide the functionalities described herein.

Custodian partner 130 of FIG. 1 contains a security engine 132 corresponding to executable processes, procedures, and/or applications with associated hardware. In other embodiments, custodian partner 130 may include additional or different modules and platforms having specialized hardware and/or software as required. Security engine 132 may correspond to security hardware and software configured to secure cryptocurrency with a secure network and/or digital vault. Custodian partner 130 may provide for custodian wallets 134 to securely hold cryptocurrencies, such as Bitcoin, Litecoin, Ether, and the like through security engine 132. Further, custodian partner 130 may provide custodian wallets 134 where values and amounts of the cryptocurrencies may be held by security engine 132 in a secure vault. Service provider server 140 may be in possession or have one of custodian wallets 134 where a balance of cryptocurrency owned by or accessible to service provider server 140 may be secured in a security vault and secure network or storage hardware. The cryptocurrency in custodian wallets 134, such as the digital wallet for liquid cryptocurrency of service provider server 140, may be balanced with one or more of liquidity wallets 124 on liquidity platform 120 using a balancing daemon by service provider server 140. For example, service provider server 140 may provide a digital ledger of cryptocurrency for different users that has been purchased, sold, and otherwise traded using cryptocurrency trading facilitated by service provider server 140. Further, to reduce instances or amounts of theft and fraud, service provider server 140 may utilize a rebalancing daemon to maintain a certain balance (e.g., percentage, percentage range, or amount within a range) of cryptocurrency in a digital wallet of service provider server 140 of custodian wallets 134. Custodian partner 130 may be accessible over network 160 to provide the cryptocurrency trading platform and processes requested and utilized by client device 110 and service provider server 140.

Service provider server 140 may be maintained, for example, by an online service provider, which may provide cryptocurrency trading operations and electronic transaction processing including use of a rebalancing daemon to secure an amount of cryptocurrency available for trading on liquidity partner 120 and an amount of cryptocurrency secured in custodian partner 130. In this regard, service provider server 140 includes one or more processing applications which may be configured to interact with client device 110, liquidity partner 120, and custodian wallet 130 to provide cryptocurrency related operations. In one example, service provider server 140 may be provided by PAYPAL®, Inc. of San Jose, Calif., USA. However, in other embodiments, service provider server 140 may be maintained by or include another type of service provider.

Service provider server 140 of FIG. 1 includes a cryptocurrency wallet application 150, a transaction processing application 142, a database 144, and a network interface component 146. Cryptocurrency wallet application 150 and transaction processing application 142 may correspond to executable processes, procedures, and/or applications with associated hardware. In other embodiments, service provider server 140 may include additional or different modules having specialized hardware and/or software as required.

Cryptocurrency wallet application 150 may correspond to one or more processes to execute modules and associated specialized hardware of service provider server 140 to provide a framework to allow liquidity partner 120 to allow for trading of cryptocurrency through liquidity partner 120, as well as securing additional cryptocurrency available to service provider server 140 and/or users of cryptocurrency wallet application 150 with custodian partner 130. In this regard, cryptocurrency wallet application 150 may correspond to specialized hardware and/or software used by a user associated with client device 110 to access and utilize cryptocurrency trading operations 152 to engage in trading cryptocurrencies available with liquidity partner 120, for example, by allowing users to purchase and/or sell cryptocurrencies. Cryptocurrency trading operations 152 may therefore access liquidity partner 120 and request trading of values and/or amounts of one or more cryptocurrencies requested by a user (e.g., in a transaction, through cryptocurrency trading platform 122.

When cryptocurrency is traded based on a user request, internal ledger 154 may update balances, values, and/or amounts of cryptocurrencies traded by the users. This allows different users to view their values and engage in further transactions for cryptocurrencies. However, as a balance of one or more digital wallets, such as one or more of liquidity wallets 124 and/or one or more of custodian wallets 134 meets, exceeds, or falls below a specific threshold (e.g., value, amount, number of units, percentage of value/amount/number, etc.), rebalancing daemon 156 may be executed to perform a rebalancing operation to maintain the one or more digital wallets at a certain level or within a range (e.g., 10% of total value of cryptocurrency). In various embodiments, different processors, engines, or modules may be required and/or utilized for different cryptocurrency types when performing rebalancing by rebalancing daemon 156.

Transaction processing application 142 may correspond to one or more processes to execute modules and associated specialized hardware of service provider server 140 to process a transaction, which may correspond to cryptocurrency trades using cryptocurrency wallet application 150. In this regard, transaction processing application 142 may correspond to specialized hardware and/or software used by a user associated with client device 110 to establish a payment account and/or digital wallet, which may be used to generate and provide user data for the user, as well as process transactions for cryptocurrencies and maintain values of cryptocurrencies based on the transactions. Transaction processing application 142 may also include or utilize different processors, engines, or modules as required for processing different cryptocurrency types and performing ledger writing or verifying on a distributed ledger. In various embodiments, financial information may be stored to the account, such as account/card numbers, cryptocurrency ledgers and balances, and/or another cryptocurrency information. A digital token for the account/wallet may be used to send and process payments, for example, through an interface provided by service provider server 140. In some embodiments, the financial information may also be used to establish a payment account. The payment account may be accessed and/or used through a browser application and/or dedicated payment application executed by client device 110 and engage in transaction processing through transaction processing application 142. Transaction processing application 142 may process the payment and may provide a transaction history to client device 110 for transaction authorization, approval, or denial.

Additionally, service provider server 140 includes database 144. Database 144 may store various identifiers associated with client device 110. Database 144 may also store account data, including payment instruments and authentication credentials, as well as transaction processing histories and data for processed transactions. Database 144 may store financial information and tokenization data. Database 144 may further store information for use in trading cryptocurrencies, as well as data for rebalancing accounts using rebalancing daemon 156 (e.g., internal ledger 154). Database 144 may also be distributed and internal ledger 154 may be distributed between different computing devices so as to provide a redundant and secure internal ledger 154. Thus, database 144 and/or internal ledger 154 may be localized and/or distributed so that different devices may record and verify transactions.

In various embodiments, service provider server 140 includes at least one network interface component 146 adapted to communicate client device 110, liquidity partner 120, and/or custodian partner 130 over network 160. In various embodiments, network interface component 146 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 160 may be implemented as a single network or a combination of multiple networks. For example, in various embodiments, network 160 may include the Internet or one or more intranets, landline networks, wireless networks, and/or other appropriate types of networks. Thus, network 160 may correspond to small scale communication networks, such as a private or local area network, or a larger scale network, such as a wide area network or the Internet, accessible by the various components of system 100.

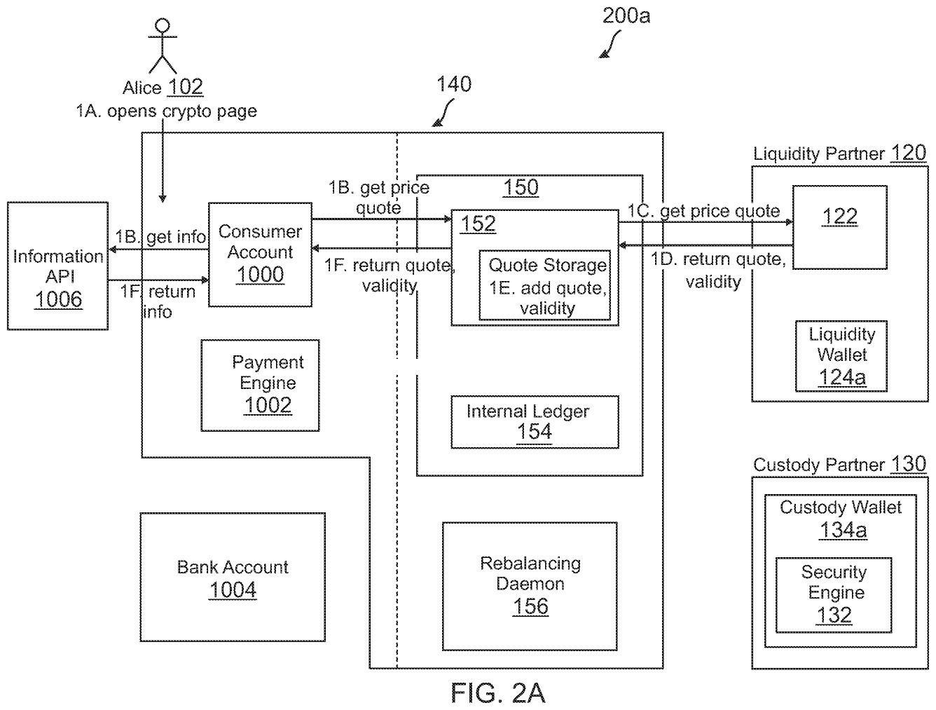

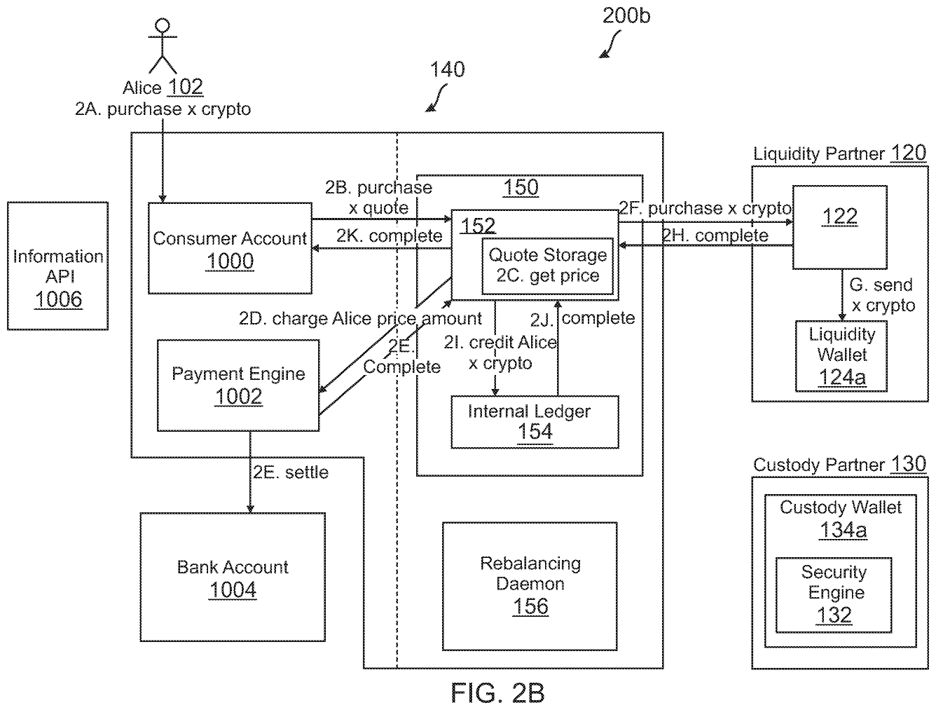

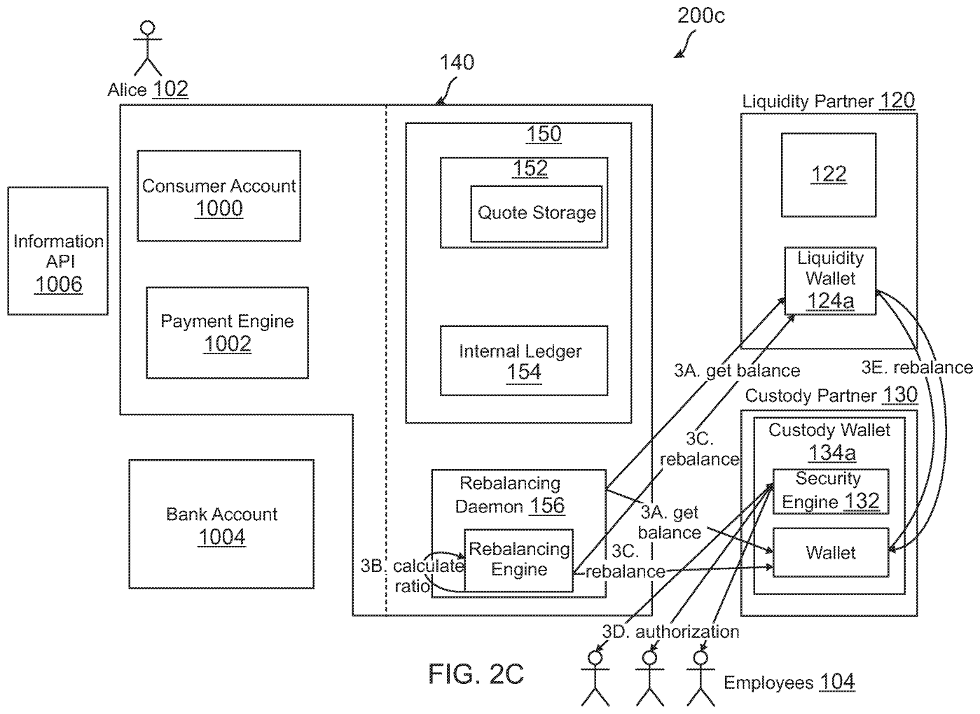

FIG. 2A-C are exemplary system interactions executed by a rebalancing daemon when performing account rebalancing with external partner platforms, according to an embodiment. System 200a of FIG. 2A includes a user 102 using service provider server 140 to receive a quote for cryptocurrency trading, for example, through client device 110 discussed in reference to system 100 of FIG. 1. System 200b of FIG. 2B includes user 102 using service provider server 140 to request a purchase of cryptocurrency, for example, through client device 110 discussed in reference to system 100 of FIG. 1. System 200c of FIG. 2C includes service provider server 140, discussed in reference to system 100 of FIG. 1, performing rebalancing of digital wallets holding cryptocurrency based on the balances of the digital wallets.

System 200a provides interactions and processes used for providing a quote to user 102 when user 102 accesses one or more interfaces and operations provided by service provider server 140 for cryptocurrency trading. In this regard, user 102 first opens one or more cryptocurrency trading pages at step 1A. This may correspond to utilizing a device, such as client device 110, to open a website or application and navigate to an interface that allows for trading cryptocurrency. In order to provide current trading information, such as a price, cost, trading availability and/or volume, or other information necessary to perform a purchase, sale, or other trade of one or more cryptocurrency types. When opening a page or interface to receive a quote, user 102 may access a consumer account 1000, such as a digital account with service provider server 140 that may be used to purchase and sell cryptocurrency through service provider server 140.

Thereafter, at step 1B, service provider server queries an information application programming interface (API) 1006 and cryptocurrency trading operations 152 of cryptocurrency wallet application 150 for cryptocurrency information used for the quote. Information API 1006 may provide information for cryptocurrency trading volumes, market capitalization, currency availability, and other information that may inform a user about different cryptocurrencies for trading. When obtaining the price quote by cryptocurrency trading operations, at step 1C, service provider server 140 may obtain a price quote from liquidity partner 120, such as by performing one or more API calls to request a price and/or value of a unit of cryptocurrency or a specified amount of cryptocurrency from cryptocurrency trading platform 122. Cryptocurrency trading platform 122 of liquidity partner 120 may return a price quote and validity period to cryptocurrency wallet application 150. The price quote may be for a number of units and/or for a requested trade, while the validity period may indicate how long the quote is valid for and may be utilized to trade cryptocurrency. Cryptocurrency trading operations 152 may then store the price quote in a quote storage at step 1E. Once the cryptocurrency price quote and information are received from information API 1006 and liquidity partner 120, at step 1F, the quote, validity period, and other cryptocurrency information from information API 1006 and liquidity partner 120 are returned to user 102 through consumer account 1000 of service provider server 140.

Referring to FIG. 2B, system 200b provides interactions and processes used for processing a purchase of cryptocurrency based on a price quote using one or more interfaces and operations provided by service provider server 140 for cryptocurrency trading. In this regard, user 102 may further utilize service provider server 140 to process a transaction, such as a sale, purchase, or other trade of cryptocurrency from liquidity partner 120. At step 2A, user 102 requests a purchase of X amount of cryptocurrency (e.g., 100 units of a cryptocurrency, $1,000 worth of a cryptocurrency, or other amount of cryptocurrency). User 102 may utilize consumer account 1000, where service provider server 140 issues a purchase of X amount of cryptocurrency from consumer account 1000 to cryptocurrency trading operations 152, at step 2B. Cryptocurrency trading operations 152 may access the quote storage to receive a price quote and/or validity period for the price quote (e.g., to determine if still valid), at step 2C.

If the price quote is valid and the purchase offer matches (or otherwise is compliant with the price quote), at step 2D, cryptocurrency wallet application 150 may then initiate a payment transaction to process a payment of the funds or monetary amount for the quested purchase of X cryptocurrency, at step 2D. This may include changing consumer account 1000 for user 102 for an amount required for the purchase or trade of X amount of cryptocurrency. The transaction may be charged to consumer account 1000 using a payment engine 1002 that may process transactions. Payment engine 1002 may then settle the amount of the purchase of X cryptocurrency with a bank account utilized by cryptocurrency wallet application 150, at step 2E. Once settlement is performed between consumer account 1000 and bank account 1004, at step 2F, completion of the payment transaction for X cryptocurrency is provided to cryptocurrency trading operations 152. At step 2F, cryptocurrency wallet application 150 further requests that X cryptocurrency is purchased and sent into liquidity wallet 124a from cryptocurrency trading platform 122 (e.g., a purchase and transfer of cryptocurrency into liquidity wallet 124a for service provider server 140).

At step 2G, liquidity partner 120 sends or transfers X amount of cryptocurrency from available cryptocurrency on cryptocurrency trading platform 122 to liquidity wallet 124a. Liquidity partner 120 then provides a completion notification of the acquisition and transfer of X cryptocurrency to liquidity wallet 124a, at step 2H. Once service provider server 140 receives an indication of the addition of X cryptocurrency into liquidity wallet 124a of service provider server 140 with liquidity partner 124a, cryptocurrency trading operations 152 may then credit user 102 in internal ledger 154 for X amount of cryptocurrency purchased by user 102 and stored in liquidity wallet 124a, at step 2I. Thereafter, internal ledger 154 then provides a completion notification to user 102 through cryptocurrency wallet application 150 to note a completion of the transaction for the cryptocurrency.

Referring to FIG. 2C, system 200c provides interactions and processes used for rebalancing digital wallets storing cryptocurrencies available to service provider server 140 for cryptocurrency trading. In this regard, at step 3A, rebalancing daemon 156 obtains balances of cryptocurrency held in liquidity wallet 124a with liquidity partner 120 and a custodian wallet 134a with custodian partner 130. In this regard, the balances may be retrieved automatically at specified intervals, such as once an hour, day, or other time period. In some embodiments, the balances may be retrieved based on other information, such as a large cryptocurrency trade or other indication that the digital wallets may be imbalanced. In some embodiments, liquidity partner 120 may push information to rebalancing daemon 156 through a websocket instead of rebalancing daemon 156 pulling data through an API. The push events may correspond to a stream of trades or other specially configured events (such as if a balance of liquidity wallet 124a falls by greater than 30% in a 24 hours period, such as when many people may be buyer and/or selling cryptocurrency). Further, liquidity partner 120 and/or custodian partner 130 may provide the balance to rebalancing daemon 156 when a particular balance is over, under, or at a particular threshold (e.g., an emergency threshold that indicates required rebalancing.

Thereafter, once the balances are received, at step 3B, one or more rations are calculated based on the balances. For example, rebalancing daemon 156 may determine a total amount of one or more cryptocurrencies held by or available to service provider server 140, which may correspond to a specific type of cryptocurrency or multiple types of cryptocurrencies. The total amount may correspond to a number of units of the cryptocurrency available to service provider server 140, a value of the cryptocurrency, or another amount of the cryptocurrency. Where multiple cryptocurrencies are user, rebalancing daemon may combine different amounts or values of the different cryptocurrencies. In some embodiments different ratios may be calculated, such as based on the particular trading volume or frequency of cryptocurrency trading. In an exemplary embodiment, liquidity wallet 124a may be required to maintain a 10% ratio of all cryptocurrency available to service provider server 140, while 90% may be stored by custodian partner 130. When this ratio is determined to be off (e.g., 14% in the liquidity wallet), rebalancing daemon may determine a rebalancing is required at step 3C. In some embodiments, a threshold may be required to be met, such as 15% in liquidity wallet 124a to cause the rebalancing. Further, an emergency rebalancing may occur where the ratio is off by more than another threshold, for example, if liquidity wallet 124a exceeds 20% of all cryptocurrency.

If a rebalancing is required at step 2C, then rebalancing daemon may request a transfer and rebalancing between liquidity wallet 124a and custodian wallet 134a. Where funds are moved from liquidity wallet 124a to custodian wallet 134a, no authorization may be required, or the authorization may be automated through rebalancing daemon 156. However, where a transfer is from custodian wallet 134a to liquidity wallet 124a, an authorization may be required from employees 104 of the service provider. Thus, at step 3D, an authorization occurs from employees 104 to security engine 132 that allows for a transfer of funds from custodian wallet 134a to liquidity wallet 124a. Thereafter, at step 3E, rebalancing occurs between liquidity wallet 124a and custodian wallet 134a. Further, rebalancing daemon 156 may further continue to monitor liquidity wallet 124a and custodian wallet 134a for further rebalancing.

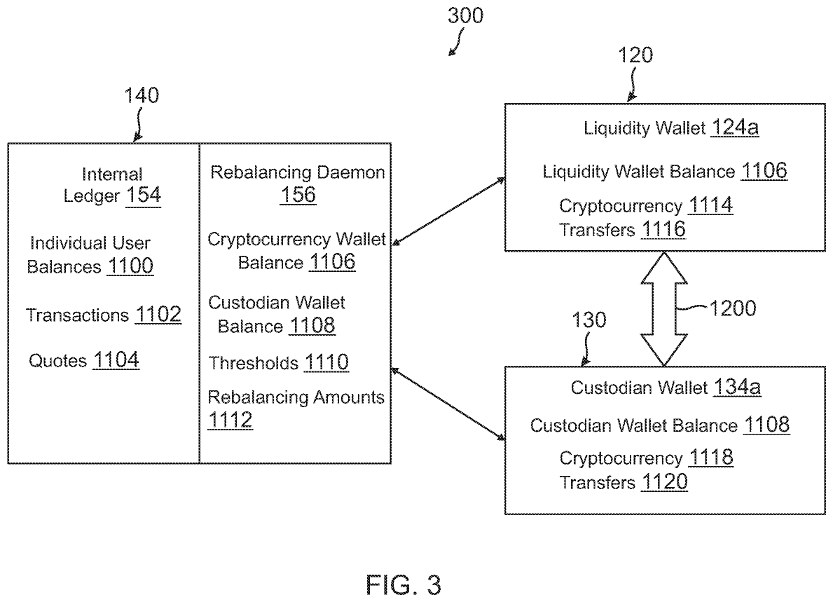

FIG. 3 is an exemplary system environment 300 where a service provider server may interact with different partner platforms to perform account balancing to secure cryptocurrency, according to an embodiment. Environment 300 includes liquidity partner 120, a custodian wallet 130, and a service provider server 140 from system 100 of FIG. 1.

Service provider server 140 may include information used for rebalancing of balances of cryptocurrency within liquidity wallet 124a with liquidity partner 120 and custodian wallet 134a with custodian partner 130. In this regard, service provider server 140 may include internal ledger 154 and rebalancing daemon 156 used for processing transactions and performing rebalancing of cryptocurrency in the digital wallets. For example, internal ledger 154 may maintain a recording of individual user balances 1000 that may be changed based on transactions 1102 for cryptocurrency based on quotes 1104 for values and/or amounts of cryptocurrency to be traded. Individual user balances 1100 may be associated with cryptocurrency available with liquidity partner 120 and custodian partner 130. When determining liquidity wallet balance 1106, cryptocurrency 1114 within liquidity wallet 124a may be provided to rebalancing daemon 156. Similarly, when determining custodian wallet balance 1108, cryptocurrency 1119 within custodian wallet 134a may be provided to rebalancing daemon 156.

A total amount of cryptocurrency used for determining ratios and rebalancing requirements may be determined using cryptocurrency 1114 and cryptocurrency 1118. When rebalancing liquidity wallet 124a and custodian wallet 134a, rebalancing daemon 156 may retrieve and/or receive a liquidity wallet balance 1106 for liquidity wallet 124 and a custodian wallet balance 1108 for custodian wallet 134a. This may occur at particular time periods or in response to triggering some event or condition. For example, every set time interval, rebalancing daemon 156 may query for updates, changes, and/or balances of liquidity wallet balance 1106 and custodian wallet balance 1108. However, in further embodiments, these balances may be provided to rebalancing daemon 156 when a particular ratio, amount, or another of thresholds 1110 is met or exceed. Thus, an emergency condition requiring rebalancing of liquidity wallet 124a and custodian wallet 134a may occur, such as if an amount in liquidity wallet 124a is over a threshold and risks fraud or theft of a particular amount. Moreover, the time period or interval for obtaining balances and performing a balance check by rebalancing daemon 156 may be adjusted or changed based on times of day, month, or year. For example, more cryptocurrency may be purchased when tax refunds are received, at Christmas, or a particular holiday or event, thereby requiring rebalancing more often of the different digital wallets. Further, a higher or lower threshold may also be changed based on these events, such as by providing a higher or lower threshold during Christmas or another holiday or event, changing the emergency thresholds based on these events to lower risk or provide a higher threshold to maintain cryptocurrency in liquidity wallet 124a, and the like.

Thereafter, rebalancing daemon 156 may determine that one or more of thresholds 1110 require rebalancing amounts 1112 to be processed for rebalancing of liquidity wallet 124a and custodian wallet 134a. Rebalancing amounts 1112 may be issued to liquidity partner 120 and custodian partner 130 to process one or more of transfers 1116 of cryptocurrency from liquidity partner 120 to custodian partner 130 and/or transfers 1120 of cryptocurrency from custodian partner 130 to liquidity partner 120. A transfer link 1200 may allow for processing of transfers 1116 and transfers 1120, which may require authorization in some embodiments.

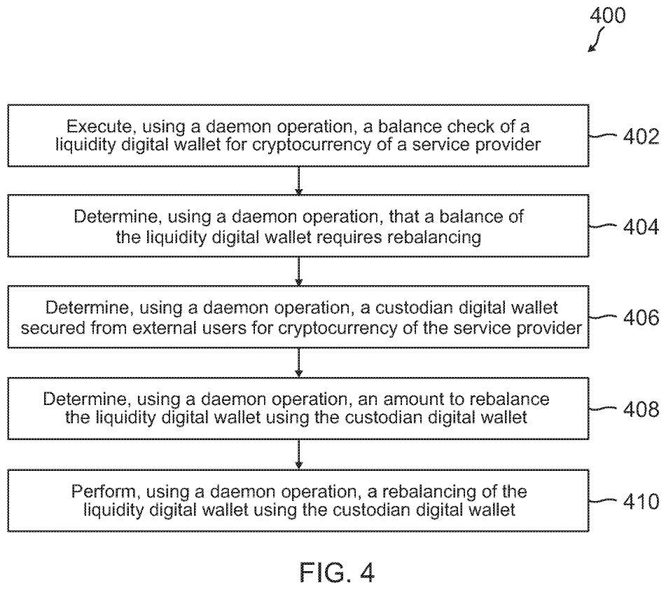

FIG. 4 is a flowchart 400 of an exemplary process for an account rebalancing daemon for use with secure digital asset custodians, according to an embodiment. Note that one or more steps, processes, and methods described herein of flowchart 400 may be omitted, performed in a different sequence, or combined as desired or appropriate.

At step 402 of flowchart 400, a balance check of a liquidity digital wallet for cryptocurrency of a service provider is executed using a daemon operation. This may include querying a liquidity partner at regular intervals for the balance of the liquidity wallet. However, in further embodiments, a balance or other balance information (e.g., when a balance falls below or is at a threshold or when a balance is at or exceeds a threshold) may be received from the liquidity partner based on various integrations and/or preferences set with the liquidity partner. In some embodiments, at step 402, a balance check may also be executed with a custodian partner having a secure custodian digital wallet that is secured through an engine and/or security hardware with the custodian partner. The balance of the custodian wallet may also be known by the service provider based on previous transfers, cryptocurrency balances, and/or balance checks and therefore may not be required where the daemon operation may access this data directly.

After performing the balance check, at step 404, the daemon operation determines that a balance of the liquidity digital wallet requires rebalancing. The daemon operation may include preferences, settings, and thresholds for balances and/or balance ranges that are required to be maintained in the liquidity wallet and/or custodian wallet. For example, the daemon may require that 10% of cryptocurrency units, value, or amount (including different types of cryptocurrency) is required to be maintained in the liquidity wallet. This may correspond to a total amount of cryptocurrency available to the service provider in the liquidity wallet and the custodian wallet, and therefore perform rebalancing when it is detected the liquidity wallet falls below 10% or increases over 10%. The daemon may also limit an amount of cryptocurrency to no more than 15%, 1,000 units, and/or $10,000 in the liquidity wallet and no less than 5%, 500 units, and/or $5,000 in the liquidity wallet, and only perform rebalancing when these thresholds are violated. In some embodiments, emergency thresholds may trigger a notification to the daemon to perform immediate rebalancing, such as if the liquidity wallet falls to 2% of the total available cryptocurrency or exceeds 20% of the total available cryptocurrency.

Once a rebalancing requirement is determined, a custodian digital wallet secured from external users for the cryptocurrency of the service provider is determined using the daemon operation, at step 406. The custodian wallet corresponds to a secured digital wallet that utilizes a secure custodian partner to prevent unauthorized external access to the custodian wallet and/or custodian partner's platform. This may utilize increased security measures, including secure computing architectures, offline storage hardware, private networks or intranets, and the like. Once the custodian digital wallet is determined, the daemon operation thereafter determines an amount to rebalance the liquidity digital wallet using the custodian digital wallet, at step 408. This may correspond to an amount to transfer between the liquidity wallet and the custodian wallet.

For example, a transfer from the liquidity wallet to the custodian wallet may occur when the liquidity wallet meets or exceeds a threshold and therefore requires removal of cryptocurrency from the liquidity wallet and storage in the custodian wallet. This may be done automatically by the daemon process as the liquidity wallet may not require additional administrative approval or authorization to transfer cryptocurrency and/or the authorization may be delegated to the daemon. Conversely, a transfer from the custodian wallet to the liquidity wallet may occur when the liquidity wallet meets or falls below a threshold and therefore requires additional cryptocurrency from the custodian wallet and storage/availability of the cryptocurrency in the liquidity wallet. However, this may require administrative approval, including approval and/or authorization from a group of administrators for the service provider and/or custodian partner. Once the rebalancing operation is determined, at step 410, a rebalancing of the liquidity digital wallet is performed using the custodian digital wallet. When performing this rebalancing, authorizations may be requested and approved as necessary. Further, the daemon may continue to monitor the liquidity wallet and custodian wallet in order to determine whether further a rebalancing is required.

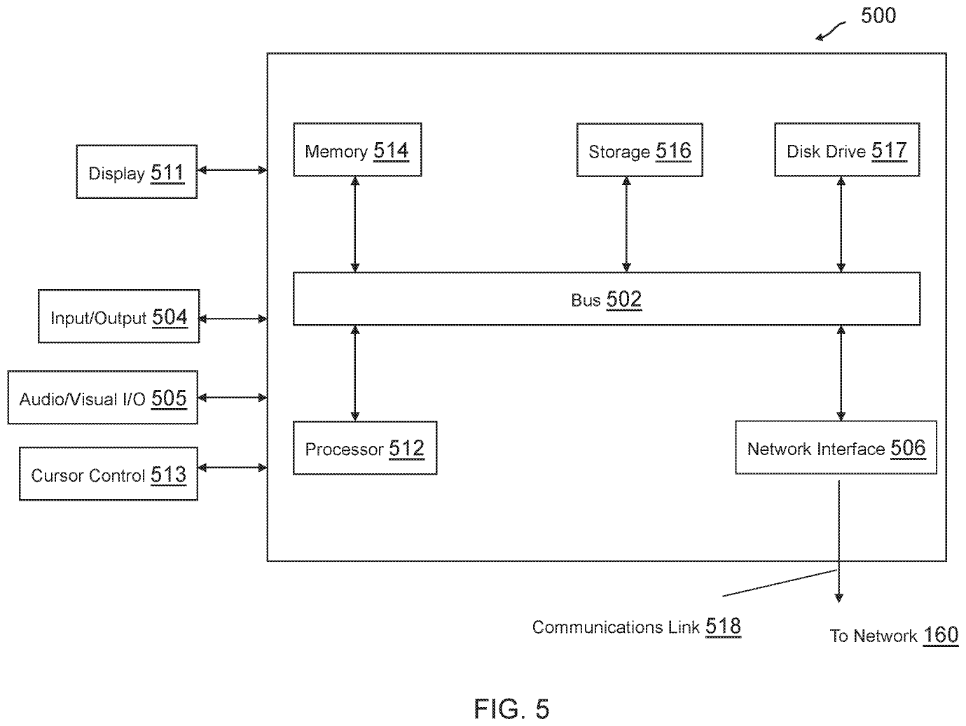

FIG. 5 is a block diagram of a computer system suitable for implementing one or more components in FIG. 1, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 160. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A service provider system comprising:
a non-transitory memory; and
one or more hardware processors coupled to the non-transitory memory and configured to read instructions from the non-transitory memory to cause the service provider system to perform operations comprising:
determining, by a rebalancing daemon operation of a cryptocurrency wallet framework associated with the service provider system, a first digital wallet and second digital wallet, wherein the first digital wallet comprises a first amount of cryptocurrency available to the service provider system, and wherein the second digital wallet comprises a second amount of the cryptocurrency;
detecting, by the rebalancing daemon operation, that the first amount of the cryptocurrency in the first digital wallet is at or over a first threshold or at or under a second threshold at a first time;
determining, by the rebalancing daemon operation, a third amount of the cryptocurrency to rebalance the first digital wallet and the second digital wallet; and
rebalancing, by the rebalancing daemon operation, the first digital wallet and the second digital wallet based on the third amount.

2. The service provider system of claim 1, wherein the first digital wallet comprises a liquidity digital wallet for the first amount of cryptocurrency with a liquidity partner platform separate from the service provider system.

3. The service provider system of claim 1, wherein the second digital wallet comprises a secure digital asset custodian in a private computing network secured from the users of the cryptocurrency wallet framework, and wherein the secure digital asset custodian requires consent from an authorization entity of the service provider system for an outgoing transfer associated with the second amount of the cryptocurrency.

4. The service provider system of claim 1, wherein the detecting that the first amount of the cryptocurrency in the first digital wallet is at or over the first threshold comprises determining that first amount meets or exceeds a first percentage of a total amount of the cryptocurrency from the first amount and the second amount, wherein the third amount comprises a second percentage of the total amount to withdraw from the first digital wallet and deposit in the second digital wallet, and wherein the rebalancing comprises:
requesting a transfer of the third amount from the first digital wallet to the second digital wallet based on the detecting that the first amount of the cryptocurrency is at or over the first threshold.

5. The service provider system of claim 4, wherein the requesting the transfer is performed without providing a transfer review request or receiving an authorization from an authorization entity of the service provider system.

6. The service provider system of claim 1, wherein the detecting that the first amount of the cryptocurrency in the first digital wallet is at or under the second threshold comprises determining that first amount is at or below a first percentage of a total amount of the cryptocurrency from the first amount and the second amount, wherein the third amount comprises a second percentage of the total amount to withdraw from the second digital wallet and deposit in the first digital wallet, and wherein the rebalancing comprises:
transferring the third amount from the second digital wallet to the first digital wallet based on the detecting that the first amount of the cryptocurrency is at or under the second threshold.

7. The service provider system of claim 6, wherein prior to the transferring, the operations further comprise:
requesting an authorization for a transfer of the third amount from the second digital wallet to the first digital wallet from an authorization entity of the service provider system; and
receiving the authorization from the authorization entity,
wherein the transferring is performed in response to the receiving the authorization.

8. The service provider system of claim 7, wherein the authorization requires a group authorization from a plurality of administrators of the authorization entity.

9. The service provider system of claim 6, wherein prior to the detecting that the first amount of the cryptocurrency is at or under the second threshold, the operations further comprise:
receiving a transaction comprising one of a transfer or a sale associated with the first amount of the cryptocurrency in the first digital wallet to an external digital wallet,
wherein the detecting is performed in response to the receiving the transaction.

10. The service provider system of claim 1, wherein the detecting is performed in response to one of a periodic time interval or the first amount being over or under a set amount threshold for the rebalancing.

11. The service provider system of claim 1, wherein the first threshold and the second threshold are associated with a total amount of the first amount and the second amount, and wherein each of the first threshold and the second threshold comprises at least one of a percentage threshold of the total amount, a cryptocurrency amount threshold of the total amount, or a monetary amount threshold of the total amount.

12. A method comprising:
receiving a cryptocurrency transaction through a service provider using a cryptocurrency digital wallet for the service provider on a cryptocurrency partner platform, wherein the cryptocurrency digital wallet is utilized by a plurality of users of the service provider for cryptocurrency transactions through the service provider;
determining, by a daemon application of the service provider, that a balance of the cryptocurrency digital wallet is at or below a threshold after the cryptocurrency transaction; and
providing, by the daemon application, an amount from a secure digital wallet to the cryptocurrency digital wallet, wherein the amount causes the balance to meet or exceed the threshold.

13. The method of claim 12, wherein prior to the providing, the method further comprises:
requesting, from at least one authorization administrator, an approval for a transfer of the amount from the secure digital wallet to the cryptocurrency digital wallet; and
receiving, from the at least one authorization administrator, the approval.

14. The method of claim 13, wherein prior to the providing the amount, the method further comprises:
in response to receiving the approval, establishing a wait time period until the transfer is executed,
wherein the providing is performed in response to expiration of the wait time period.

15. The method of claim 12, wherein the cryptocurrency transaction comprises a sale of cryptocurrency through the service provider using the cryptocurrency partner platform by one of the plurality of users, and wherein a transaction amount for the cryptocurrency transaction is withdrawn from the cryptocurrency digital wallet for the service provider on the cryptocurrency partner platform.

16. The method of claim 12, wherein prior to the receiving the cryptocurrency transaction, the method further comprises:
requesting a quote on a value associated with the cryptocurrency transaction from the cryptocurrency partner platform; and
causing the quote to be displayed to at least one of the plurality of users via a user interface provided by the service provider.

17. The method of claim 12, wherein the secure digital wallet resides on an internal network separate from the cryptocurrency partner platform.

18. A non-transitory machine-readable medium having stored thereon machine-readable instructions executable to cause a machine to perform operations comprising:
executing a balance check of a balance of cryptocurrency for a cryptocurrency digital wallet on a partner platform using a daemon program of a service provider;
determining that the balance meets or exceeds a threshold for the cryptocurrency available in the cryptocurrency digital wallet using the daemon program;
determining an amount of the balance to transmit to a custodian digital wallet using the daemon program; and
requesting a transfer of the amount to the custodian digital wallet using the daemon program.

19. The non-transitory machine-readable medium of claim 18, wherein the requesting is performed without user input from an administrator associated with the service provider.

20. The non-transitory machine-readable medium of claim 18, wherein the amount is sufficient to cause the balance of the cryptocurrency digital wallet to reach a target percentage of an overall amount in the cryptocurrency in the cryptocurrency digital wallet and the custodian digital wallet.
